(19) United States
(12) Patent Application Publication
(10) Pub. No.: US 2026/0075409 A1
(43) Pub. Date: Mar. 12, 2026

(54) METHOD FOR DYNAMICALLY SELECTING A PORT OF EUICC SUPPORTING MULTIPLE ENABLED PROFILES AND SYSTEM THEREOF

(71) Applicant: Samsung Electronics Co., Ltd., Suwon-si (KR)

(72) Inventors: Anuj RAJPUT, Kanpur (IN); Vikas KUMAR, Ghaziabad (IN); Manjot KAUR, Ludhiana (IN)

(21) Appl. No.: 18/970,227

(22) Filed: Dec. 5, 2024

Related U.S. Application Data
(63) Continuation of application No. PCT/KR2024/018030, filed on Nov. 15, 2024.

(30) Foreign Application Priority Data
Sep. 10, 2024 (IN) 202411068214

(51) Int. Cl. H04W 8/26; H04W 8/18; H04W 24/08

(52) U.S. Cl. CPC H04W 8/265; H04W 8/183; H04W 24/08

(57) ABSTRACT

The present disclosure relates to method and apparatus for dynamically selecting a port of an Embedded Universal Integrated Circuit Card (eUICC) supporting Multiple Enabled Profiles (MEP) mode in a device. The method includes: receiving a request to activate a profile from a plurality of profiles stored in the eUICC; monitoring ongoing communication on one or more active ports of the eUICC; and selecting a port from the one or more active ports of the eUICC based on the ongoing communication to activate the profile. The method provides effective and efficient profiles management within the eUICCs by introducing dynamic port selection and robust error handling mechanisms. This ensures greater flexibility and reliability in profile activation and deactivation processes, even in the event of malfunctions or communication failures.

### CROSS-REFERENCE TO RELATED APPLICATIONS

This application is a continuation of International Application No. PCT/KR2024/018030 designating the United States, and filed on Nov. 15, 2024, in the Korean Intellectual Property Receiving Office and claiming priority to Indian Patent Application No. 202411068214, filed on Sep. 10, 2024, in the Indian Patent Office, the disclosures of each of which are incorporated by reference herein in their entireties.

### BACKGROUND

### Field

The disclosure relates to management of profiles included in an Embedded Universal Integrated Circuit Card (eUICC). For example, the present disclosure relates to a system and method for dynamically selecting a port of the eUICC that supports Multiple Enabled Profiles (MEP) mode in a user equipment.

### Description of Related Art

The statements in this section merely provide background information related to the present disclosure and may not constitute prior art.

In telecommunications, Embedded Universal Integrated Circuit Cards (eUICCs) offer enhanced flexibility and functionality by supporting multiple profiles within a single card. These profiles include Independent Subscription Downloadable Remote (ISD-R) profiles, which allow users to switch between different network operators without needing to physically replace the SIM card.

However, in current implementations, selection of an ISD-R port preset in a user device has significant limitations. The selection of the ISD-R port is managed either by the Local Profile Assistant (LPA) or by the eUICC. This selection process is often predetermined, either fixed or arbitrary, before initiating any profile management sequences. Current solution in ISD-R profile selection, the LPA or the ISD-R does not allow UE to efficiently switch a port for profiles selection when profiles are switched during restart, switched off, network configuration, selection of network services.

One of the drawbacks of the existing system is the inability of the user device to efficiently switch between ports when different profiles are activated or deactivated. This results in users being locked into a single network operator with a fixed port assignment, which is particularly problematic in scenarios requiring dynamic network access. Consequently, this affects the user experience and limits the potential of the eUICC technology in multi-network environments.

Thus, there is a need for innovative techniques that can address the above-mentioned problems.

### SUMMARY

According to an example embodiment of the present disclosure, a method for dynamically selecting a port of an Embedded Universal Integrated Circuit Card (eUICC) supporting Multiple Enabled Profiles (MEP) mode in a device, is disclosed. The method comprises: receiving a request to activate a profile from a plurality of profiles stored in the eUICC; monitoring ongoing communication on one or more active ports of the eUICC; and selecting a port from the one or more active ports of the eUICC based on the ongoing communication to activate the profile.

According to an example embodiment of the present disclosure, the ongoing communication relates to mobile network operator (MNO) services supported by one or more currently active profiles corresponding to the one or more active ports.

In an example embodiment of the present disclosure, wherein selecting the port from the one or more active ports of the eUICC based on the ongoing communication, comprises: storing information of the ongoing communication using a monitor module, transferring the information of the ongoing communication from the monitor module to a port selector module, and selecting the port from the one or more active ports by the port selector module.

In example embodiment of the present disclosure, the method further comprises: creating a communication channel between a Local Profile Assistant (LPA) and an Issuer Security Domain-Root (ISD-R) on the selected port; sending a command, from the LPA to the ISD-R, to deactivate a currently active profile on the selected port by closing a previous logical communication channel associated with the selected port and to activate the profile indicated in the received request.

In an example embodiment of the present disclosure, the method further comprises: determining, by the ISD-R, whether the previous logical communication channel is closed or open; based on the determining, perform one of the following: based on the previous logical communication channel being closed, initiating a refresh request for updating the plurality of profiles on the eUICC to deactivate the currently active profile and activate the profile, and based on the previous logical communication channel being open, selecting a new port with least priority based on the ongoing communication and re-initiating creation of the communication channel between the LPA and ISD-R on the new port.

In an example embodiment of the present disclosure, the method further comprises: determining whether the refresh request is successful; based on the determining, performing one of the following: based on the refresh request being successful, initializing a reset process for the device to activate the profile, and based on the refresh request not being successful, selecting a new port with least priority based on the ongoing communication and re-initiating creation of the communication channel between the LPA and ISD-R on the new port.

In an example embodiment of the present disclosure, after initializing the reset process for the device to activate the profile, the method further comprises: sending a notification to a Subscription Manager Data Preparation (SM-DP+) server related to enabling of the profile and monitoring a response from the SM-DP+ server in reply to the notification; determining whether the reply is received from the SM-DP+ server within a specified time period, and upon a not receiving the reply from the SM-DP+ server within the specified time period, selecting a new port with least priority based on the ongoing communication and re-initiating creation of the communication channel between the LPA and ISD-R on the new port.

In an example embodiment of the present disclosure, based on receiving of the reply from the SM-DP+ server within the specified time period, the method further comprises: initializing closing of the communication channel between the LPA and the ISD-R and determining whether the communication channel is closed; based on the determining, performing one of: activating the profile based on the communication channel being closed, and selecting a new port with least priority based on the ongoing communication and re-initiating creation of the communication channel between the LPA and ISD-R on the new port based on the communication channel not being closed.

In an example embodiment of the present disclosure, an apparatus configured to dynamically select a port of an Embedded Universal Integrated Circuit Card (eUICC) supporting Multiple Enabled Profiles (MEP) mode in a device, is disclosed. The apparatus comprises: at least one processor, comprising processing circuitry, individually and/or collectively, configured to: receive a request to activate a profile from a plurality of profiles stored in the eUICC, monitor ongoing communication on one or more active ports of the eUICC, and select a port from the one or more active ports of the eUICC based on the ongoing communication.

The foregoing summary is illustrative and is not intended to be in any way limiting. In addition to the illustrative aspects, various example embodiments, and features described above, further aspects, embodiments, and features will become apparent by reference to the drawings and the following detailed description.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1A is a diagram illustrating a MEP-A selection model according to existing techniques;

FIG. 1B is a diagram illustrating the architecture for the MEP-A selection mode in accordance with existing techniques;

FIG. 2A is a diagram illustrating a MEP-B selection model in accordance with existing techniques;

FIG. 2B is a diagram illustrating the architecture for the MEP-B selection mode in accordance with existing techniques;

FIG. 3 is a signal flow diagram illustrating port selection for a profile in accordance with the existing techniques;

FIG. 4 is a block diagram illustrating an example configuration of an apparatus to dynamically select a Port of an Embedded Universal Integrated Circuit Card (eUICC) supporting Multiple Enabled Profiles (MEP) mode in a user device, according to various embodiments;

FIG. 5 is a block diagram illustrating an example configuration of a user device according to various embodiments;

FIG. 6 is a signal flow diagram illustrating example port selection for e-SIM profile according to various embodiments;

FIG. 7 is a flowchart illustrating example operations performed for activating a profile according to various embodiments;

FIG. 8 is a diagram illustrating an example configuration of a monitor along with interconnection of the monitor with the other elements of the device according to various embodiments;

FIG. 9 is a signal flow diagram illustrating example operations for a monitor according to various embodiments;

FIG. 10 is a diagram illustrating example interconnection of a port selector with other elements of the device according to various embodiments;

FIG. 11 is a signal flow diagram illustrating example operations for a port selector according to various embodiments;

FIG. 12 is a block diagram illustrating an example configuration of a Device LPA (LPAd) along with interconnection of the LPAd with the other elements of the device according to various embodiments;

FIG. 13 is a signal flow diagram illustrating example operations for a LPAd according to various embodiments;

FIG. 14 is a block diagram illustrating an example configuration of an ISD-R along with interconnection of the ISD-R with the other elements of the device according to various embodiments;

FIG. 15 is a flowchart illustrating an example method for dynamically selecting a port of an Embedded Universal Integrated Circuit Card (eUICC) supporting Multiple Enabled Profiles (MEP) mode in a device, according to various embodiments; and

FIG. 16 is a diagram illustrating a use example according to various embodiments.

It should be appreciated by those skilled in the art that any block diagrams herein represent conceptual views of the illustrative systems embodying the principles of the present subject matter. Similarly, it will be appreciated that any flowcharts, flow diagrams, state transition diagrams, pseudo code, and the like represent various processes which may be substantially represented in computer-readable medium and executed by a computer or processor, whether or not such computer or processor is explicitly shown.

### DETAILED DESCRIPTION

Reference will now be made to the various example embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would occur to one skilled in the art to which the disclosure relates.

It will be understood by those skilled in the art that the foregoing general description and the following detailed description are explanatory and are not intended to be restrictive thereof.

In the present disclosure, the word “exemplary” is used herein to refer to “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, various example embodiments are shown by way of example in the drawings and will be described in greater detail below. It should be understood, however that it is not intended to limit the disclosure to the particular forms disclosed, but on the contrary, the disclosure is intended to cover all modifications, equivalents, and alternatives falling within the spirit and the scope of the disclosure.

The terms “comprise”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The terms like “at least one” and “one or more” may be used interchangeably throughout the description. Terms like “Device LPA” and “LPAd” may be used interchangeably throughout the disclosure. The terms “eUICC LPA” and “LPAe” may be used interchangeably throughout the disclosure. In the following detailed description, reference is made to the accompanying drawings that form a part hereof, and in which are shown by way of illustration specific embodiments in which the disclosure may be practiced. The following description is not to be taken in a limiting sense. In the following description, well known functions or constructions are not described in detail since they would obscure the description with unnecessary detail.

Through this disclosure, the term “eUICC” may be understood as an integrated circuit, (IC) that securely stores subscription profile(s). A profile in an eUICC may host an international mobile subscriber identity number (IMSI), a unique serial number (ICCID), cryptographic encryption/decryption keys, security authentication and ciphering information, temporary information related to the local network, a list of the services the user has access to, and two passwords: a personal identification number (PIN) for ordinary use, and a personal unblocking code (PUK) for PIN unlocking, which are used to uniquely identify and authenticate a subscriber on a terminal device, such as an M2M device, a mobile phone, a personal computer and so on. In addition, a profile in an eUICC may contain a profile name.

The eUICC may refer to a component that allows for over-the-air (OTA) switching of Mobile Network Operators (MNOs). The e-UICC also allows to activate new MNO profile using remote SIM provisioning. The eUICC may have multiple profiles, which may be referred to as Multiple Enable profile (MEP). The one or more profile may be enabled simultaneously using one or more basebands. There are two types of MEP profile models: MEP-A and MEP-B. The MEP-A and MEP-B are options for the selection of the issuer security domain root (ISD-R) and the selection of e-SIM ports/user device ports as specified in GSMA SGP V22 3.0. The ISD-R may be considered as the highest privileged security domain on the eUICC and acts as a gateway for all communication with the eUICC from external entities like the Subscription Manager (SM).

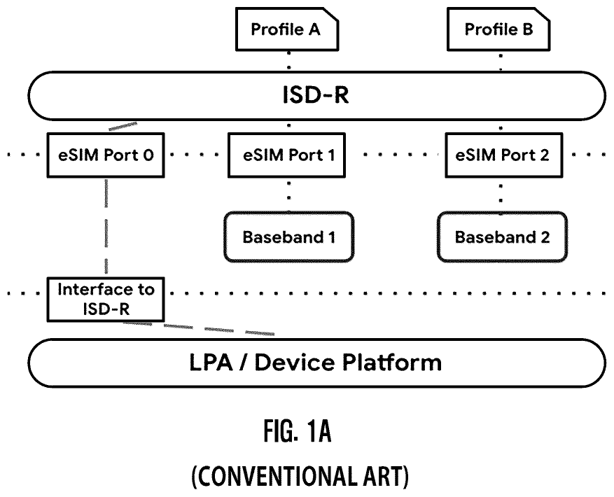

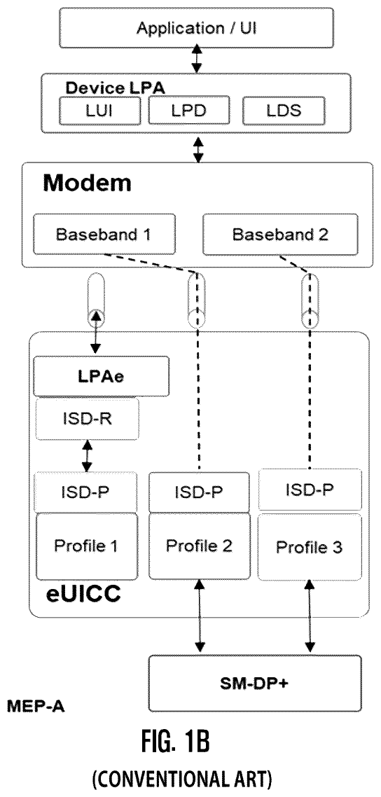

FIG. 1A is a diagram illustrating the MEP-A selection model used in profile management for Embedded Universal Integrated Circuit Cards (eUICCs), in accordance with existing techniques. In the MEP-A1 model, the selection of the ISD-R is fixed to port 0, which is designated as the command port. The profile management, including selection and switching, is handled through e-SIM ports numbered 1 and higher. In this, all enable and disable commands, such as the ES10 commands, are exclusively transmitted through port 0. The architecture of the MEP-A selection model is shown in FIG. 1B.

FIG. 1B is a diagram illustrating an architecture for the MEP-A selection model. The apparatus 100 depicted includes several components: a user interface, a Device Local Profile Assistant (LPAd), a modem, and an eUICC. The eUICC may be communicatively coupled to a Subscription Manager Data Preparation (SM-DP+) server, which plays a role in managing subscription profiles. In the MEP-A model, the command port and target port are always different, which are selected by the LPA. However, since the ISD-R selection relies solely on a dedicated port (port 0), a hardware failure in that specific port may potentially hinder communication with the e-SIM provider. Further, the MEP-A1 relies on dedicated ports for specific functions, such as ISD-R selection and profile selection, which limits flexibility compared to the MEP-B. The MEP-B allows any port to be used for any function.

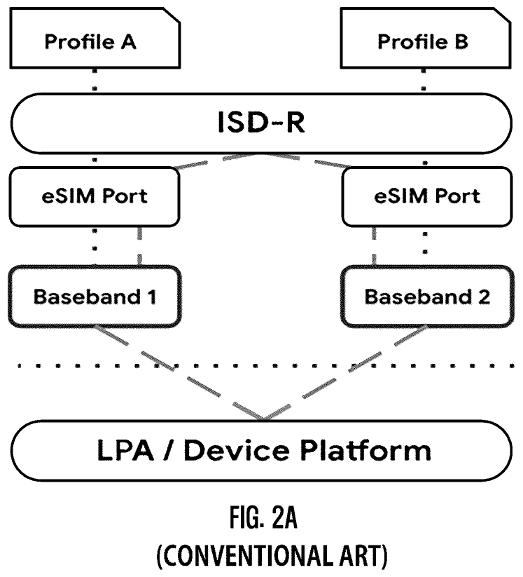

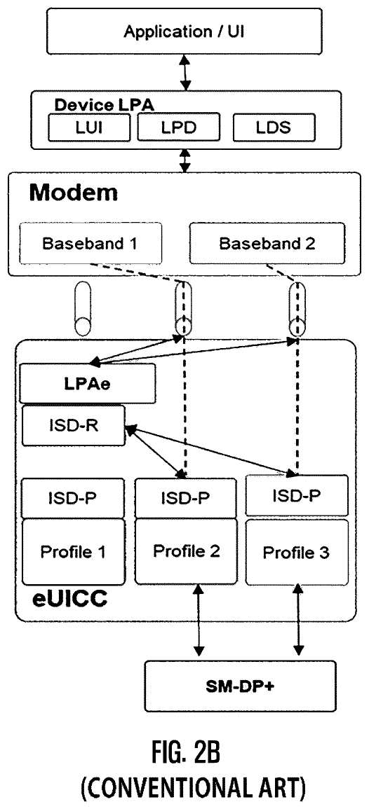

FIG. 2A is a diagram illustrating a MEP-B selection model used in profile management for eUICCs, in accordance with existing techniques. In MEP-B, the ISD-R is selected on any port and any port can be assigned a profile. The enable and disable commands may be sent to the port where the profile needs to be enabled or disabled (where a refresh is pending). The architecture of the MEP-A selection model is shown in FIG. 2B.

FIG. 2B is a diagram illustrating the architecture of the MEP-B selection model. In this model, the command port and the target port are effectively the same. However, this flexibility introduces a requirement for precise port identification. The device must be capable of correctly distinguishing and managing ports designated for the ISD-R communication and those assigned for profile-related activities. The proper identification and management ensure that the system functions correctly and that profiles are handled effectively, while maintaining the advantages of flexibility without compromising operational integrity.

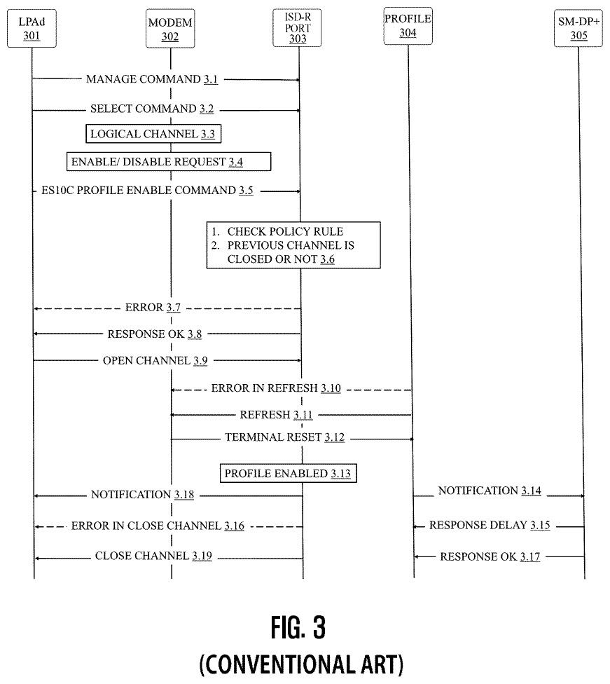

FIG. 3 is a signal flow diagram illustrating operations of port selection for a profile in accordance with the existing technique. At step 3.1, a device LPA 301 may send a “manage” command to the ISD-R port 303 and subsequently may send a “Select” command at step 3.2. In response to the commands, a logical channel is created between the device LPA 301 and the ISD-R port 303, at step 3.3. In an embodiment, the ISD-R port 303 selected for communication is set to port 0 for the MEP-A and profile target port for the MEP-B. At step 3.4, an Enable/Disable profile request may be received from the user of the device. Upon receiving the request, an ES10 command may be sent from the LPA of the device LPA 301 to the ISD-R 303, at step 3.5.

Upon receiving the command, the ISD-R 303 may check if a previous channel is closed, at step 3.6. If the previous channel is not closed, an error message may be sent to the LPAd 301 at step 3.7. Whereas, when the previous channel is closed, the ISD-R 303 may send a “ok” response to the LPA of the device 301 at step 3.8. Upon receiving the “ok” response, the LPAd 301 may open a channel between the LPAd 301 and the ISD-R 303 at step 3.9. After opening the channel, the ISD-P 304 may send a refresh command to the modem 302, but if error happen in refresh the request is failed, as shown at steps 3.10 and 3.11. In response to the refresh command, the modem 302 sends a terminal reset command to the ISD-P 304, at 3.12. Thereafter, the profile is enabled at step 3.13. Furthermore, at step 3.14, a notification is sent to the LPAd 301 if the profile is successfully enabled. Alternatively, the ISD-R port 303 may send an error to the LPAd 301 when the profile enable fails. The ISD-P profile 304 may send a notification to the SM-DP+ and may monitor for a response from the SM-DP+. When the response “ok” is received from the SM-DP+, the ISD-R 303 may close the channel. However, in case there is any delay in the response from the SM-DP+, the ISD-R port 303 may send an error message to the LPAd 301.

However, in such conventional ISD-R profile selection, the LPAd 301 or the ISD-R port 303 does not allow the user device to efficiently switch a port for profiles selection when profiles are switched during (restart, switched off, network configuration, selection of network services) and the ports are selected randomly. Also, when a Port for a profile is selected, the existing techniques do not consider that existing profile service/cost/pricing/service offering with associated with Port were more important or not. Also, in some situations, the users are locked into a single operator. The multiple port switching involvement also leads to security and overhead issues. The upcoming paragraphs disclose the solution(s) provided to address the above-mentioned challenges.

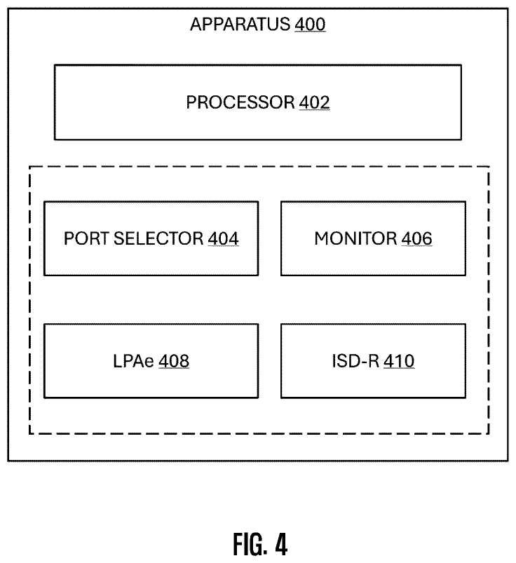

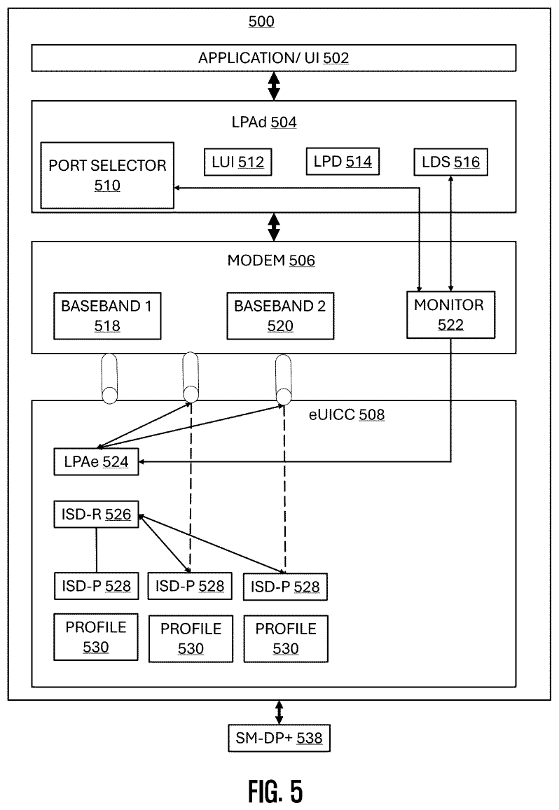

FIG. 4 is a block diagram illustrating an example configuration of an apparatus 400 to dynamically select a port of an Embedded Universal Integrated Circuit Card (eUICC) supporting Multiple Enabled Profiles (MEP) mode in a user device, according to various embodiments. The apparatus 400 may comprise various elements, but not limited to, a processor (e.g., including processing circuitry) 402, a port selector (e.g., including various circuitry and/or executable program instructions) 404, a monitor (e.g., including various circuitry and/or executable program instructions) 406, a LPAe (e.g., including various circuitry and/or executable program instructions) 408 and an ISD-R 410. These elements may be communicatively coupled to each other. In an embodiment, the port selector 404, the monitor 406, the LPAe 408 and the ISD-R 410 may be implemented as software modules. These modules may be stored in a memory (not shown in FIG. 4) and the processor 402 may dynamically select a port of the eUICC by executing these modules. In an embodiment, the port selector 404, the monitor 406, the LPAe 408 and the ISD-R 410 may be implemented as dedicated hardware units, working in conjunction with the processor 402. The apparatus 400 having the port selector 404, the monitor 406, the LPAe 408 and the ISD-R 410 is explained in greater detail with reference to FIG. 5. The processor 402 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /isclosed functions, e.g., in a distributed manner. At least one processor may execute program instructions to achieve or perform various functions.

FIG. 5 is a block diagram illustrating an example configuration of a user device 500 comprising the apparatus 400 according to various embodiments. The device 500 comprises a user interface (e.g., including interface circuitry) 502, an LPAd 504, a modem 506, and eUICC 508, but not limited thereto. The LPAd 504 may comprise the port selector 510, a LUI 512, an LPD 514, an LDS 516, but is not limited thereto. The modem 506 comprises a first baseband 518 and a second baseband 520, but is not limited thereto. The first baseband and the second baseband may also be referred to as baseband 1 518 and baseband 2 520, respectively. Further, the eUICC 508 comprises a plurality of ISD-Ps 528, an ISD-R 526 and an LPAe 524, but not limited thereto. Each of the plurality of ISD-Ps is associated with a separate profile. In an example embodiment, the user device 500 may be communicatively coupled with the SM-DP+ 538 (not shown in FIG. 5). The operations of all elements of the user device 500 may be controlled by the processor 402 shown in FIG. 4.

According to an embodiment of the present disclosure, the user interface 502 may receive a request to enable/disable a profile of an e-SIM of the user device 500. The request may be triggered by a user of the user device 500 to enable/disable a profile of the e-SIM. Upon receiving the request, the port selector 510 may select a port for command communication, such as ES10 command, from among the available ports based on monitored communication activity of respective service profile reported by the monitor module. Further, the LUI 512 (Local User Interface) may handle user interactions specific to the profile management. The LPD 514 (Local Profile Database) may store information related to profiles, and the LDS 516 (Local Data Store) may keep data relevant to the device's operation and profiles.

The monitor 522 may monitor the ongoing communication on one or more active ports. The communication may belong to respective MNO service profile. The port selector 510 may select the port based on the services provided by available port MNO. The LPAd 504 may create a communication channel with the ISD-R 526 on the port provided by the port selector 510. The LPAd 504 may open a channel between the device LPA 504 and the ISD-R. The device LPA 504 may send the Es10 C enable/disable command to ISD-R 526. The ISD-R 526 may receive the request via the LPA of the eUICC (LPAe) 524. The ISD-R 526 may first check profile is present and previous request channel is closed, if previous channel is not closed or profile is not present then ISD-R 526 may send the error to the device LPA 504.

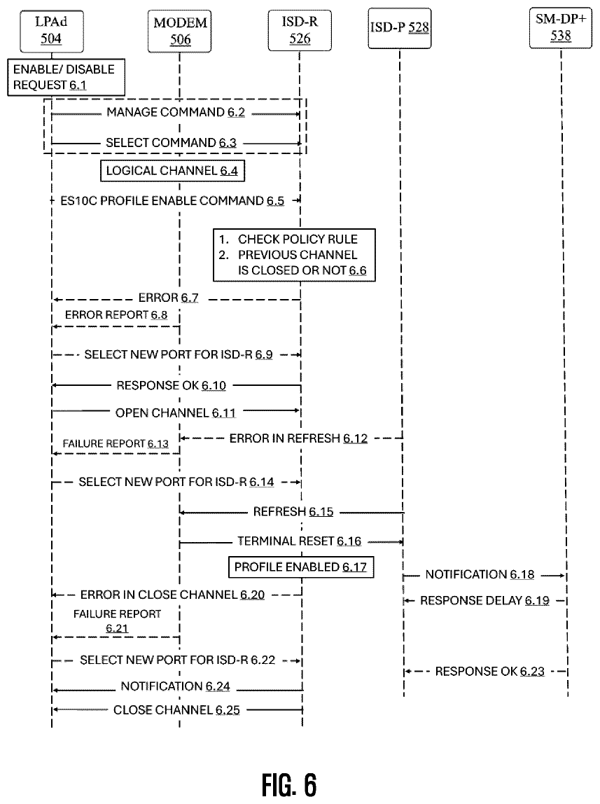

If there is no failure, then profile is enabled and refresh trigger by the e-SIM profile. If any error happens in open/close channel or in refresh then device LPA 504 may create a channel with ISD-R 526 over new port which is selected by port selector 510, and then ISD-R 526 starts the communication over new port. If failure happens in the ongoing communication, then it sends the message to device LPA 504. If the new port selection is a result of an error, the monitor 522 provides the error information and the last state of the previous request to the LPAd 504. The LPAd 504 then requests the ISD-R 526 to resume the process from the same point where it was interrupted, thereby facilitating a seamless transition and recovery. In an embodiment, the function of the modem 506 is to facilitate communication between the user device and external networks. The functionality of the device is explained in detail in conjunction with FIG. 6.

FIG. 6 is a signal flow diagram illustrating example operations of port selection for e-SIM profile According to various embodiments. The device LPA 504 may receive a request to enable/disable a profile of the e-SIM (as shown at step 6.1). In response to receiving the request, the device LPA 504 may send a manage command to the ISD-R 526 (at step 6.2). The manage command is used to manage the profile operations by instructing the ISD-R 526 to prepare for profile changes. Subsequently, the device LPA 504 may also send a select command to the ISD-R 526 (at step 6.3). The select command is intended to specify which profile or port should be targeted for the subsequent operations. In response to sending the manage command and the select command, a logical channel may be created between the device LPA 504 and ISD-R 526, at step 6.4. This logical channel facilitates communication and data transfer between these components, enabling the execution of profile-related commands.

Once the logical channel is established, the device LPA 504 may send a profile enable/disable command, such as Es10C profile enable command, to the ISD-R 526, at step 6.5. The profile enable/disable command is to send to deactivate a currently active profile on the selected port by closing a previous logical communication channel associated with the selected port and to activate the profile indicated in the received request.

Upon receiving the profile enable/disable command, the ISD-R 526 may determine whether the previous logical communication channel associated with the selected port is closed or open, at step 6.6. In an embodiment, when the previous logical communication channel is determined to be open, the ISD-R 526 may send an error message to the device LPA 504 (at step 6.7). This error message indicates that the requested operation cannot be completed because the existing channel has not been properly closed. Subsequently, the modem 506 share a failure report with the device LPA 504 (at step 6.8). This report provides further context and information about the failure encountered during the profile management process. Upon receiving the error message and the failure report, the device LPA 504 may select a new port with least priority based on the ongoing communication (at step 6.9). Thereafter, the ISD-R 526 re-initiates the creation of the communication channel between the device LPA 504 and ISD-R 526 on the new port. Upon receiving the new port, the channel on the old port may be closed and a new logical channel is created on the new port. In an embodiment, the LPAd 504 may send a request to the ISD-R 526 to close the previous channel and create the new channel over the new port. The LPAd 504 may request the ISD-R 526 to start the process from same point. If the new port selection is a result of an error, the monitor 522 provides the error information and the last state of the previous request to the LPAd 504. The LPAd 504 then requests the ISD-R 526 to resume the process from the same point where it was interrupted, thereby facilitating a seamless transition and recovery. For this, the LPAd 504 may send a new Es10 command to share the previous state to the ISD-R 526. The ISD-R 526 may check if process needs to restart or can be started from previous state and share the response to the LPAd 504. Accordingly, the LPAd 504 may either receive a n ‘ok’ response from the ISD-R 526, or may receive a notification that restart is required for the request. This re-establishment of the channel ensures that the profile enable/disable command can be processed correctly, and the required profile management operations can proceed without interruption.

In an embodiment, when the previous logical communication channel is determined to be closed, the ISD-R 526 may send an ‘ok’ response to the device LPA 504 (at step 6.10). This response indicates that the previous logical communication channel has been successfully closed, and the system is ready to proceed with the profile management commands. Upon receiving the ‘ok’ response, the device LPA 504 may open a channel for the profile to be activated (at step 6.11). This channel may be used to manage the profile-related commands. Further, a refresh request may be initiated to update the plurality of profiles on the eUICC 508 in order to deactivate the currently active profile and activate the profile as requested. This refresh request serves two main purposes: i) triggering the deactivation of the currently active profile on the eUICC and ii) activating the profile specified in the initial request by updating the eUICC with the new profile information. The ISD-P 528 may determine whether the refresh request is successful or failed.

In an embodiment, when the refresh request is failed, the ISD-P 528 may indicate the failure to the modem 506 by sending an Error in Refresh message (at step 6.12). This message indicates that the profile update process did not complete as expected. The modem 506 sends a failure report to the device LPA 504 (at step 6.13). Upon receiving the failure report, the 504 may again select a new port with the least priority based on the ongoing communication and re-initiating creation of the communication channel between the device LPA 504 and ISD-R 526 on the new port, aiming to resolve the issue and retry the profile management process. In an embodiment, when the refresh request is successful, the ISD-P 528 may notify the modem 506 by sending a “refresh” message. This indicates that the refresh request was successfully processed, and the profile has been updated. Upon receiving the notification for successful refresh, the modem 506 may initialize a reset process for the device to activate the profile and send a terminal reset command to the ISD-P 528 (at step 6.16). After terminal reset, the profile is enabled (at step 6.17).

Furthermore, a notification may be sent to a Subscription Manager Data Preparation (SM-DP+) server related to enabling of the profile (at step 6.18). The response from the SM-DP+ server 538 in reply to the notification is monitored. In case of any delay in response from the SM-DP+ 538 e.g., upon a non-receipt of the reply from the SM-DP+ server within the predefined time period, an error message is sent to the device LPA 504. Further, a failure report is sent to the device LPA 504. In response, the device LPA 504 may select a new port with least priority based on the ongoing communication and re-initiate creation of the communication channel between the LPA and ISD-R on the new port.

In an embodiment, upon a receipt of the reply from the SM-DP+ 538 within the predefined time period, the ISD-R 526 may send a notification to the device LPA 504 to initialize closing of the communication channel between the device LPA 504 and the ISD-R 526. The ISD-R 526 may close the channel (at step 6.25). The profile may be activated when the communication channel is closed.

The various embodiments described provide an improvement in the management of profiles within the eUICCs by introducing dynamic port selection and robust error handling mechanisms. This ensures greater flexibility and reliability in profile activation and deactivation processes, even in the event of hardware malfunctions or communication failures. The ability to adaptively select alternative ports and manage errors effectively enhances overall operational efficiency and ensures that profile updates are applied promptly and accurately.

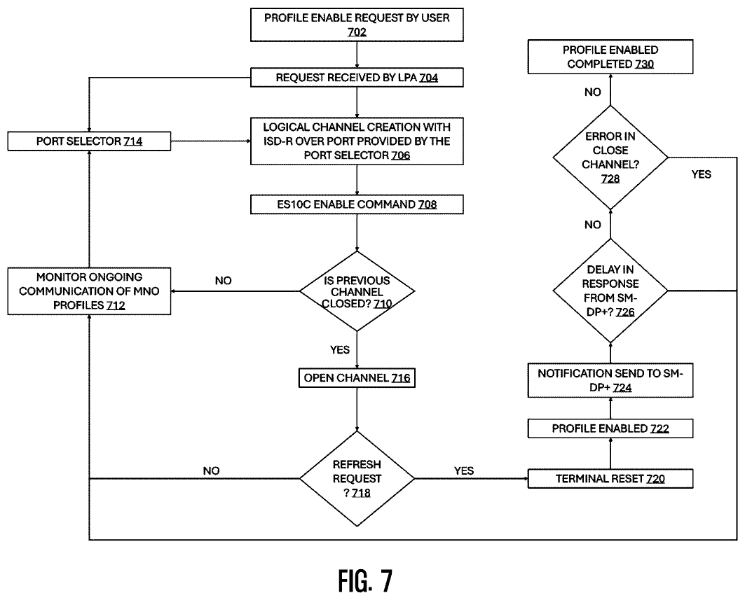

FIG. 7 is a flowchart illustrating example operations performed for activating a profile according to various embodiments. At step 702, profile enable/disable request is triggered by a user. The request is received by the device LPA 504 at step 704. At step 706, a logical channel is created with ISD-R 526 over port provided by a port selector 510. The port selector 510 selects the port based on the ongoing communication of MNO profiles at step 714. After the creation of the channel, an Es10C enable command may be sent at step 708. Upon receiving the command, the previous channel status is checked. It is determined whether the previous channel is closed. In case the channel is not closed, the step 712 is performed e.g., ongoing communication of the MNO profiles is monitored by the monitor. Based on the monitored ongoing communication, a new port is selected by the port selector 510 at step 510.

However, when the previous channel is determined as closed at step 710, a new communication channel may be opened to enable/activate the profile, as requested at step 716. Once the new communication channel is open, a refresh request is initiated and it is determined whether the refresh was successful, at step 718. If the refresh is not performed successfully, the step 712 is performed again e.g., ongoing communication of the MNO profiles is monitored by the monitor. Based on the monitored ongoing communication, a new port is selected by the port selector 510 at step 510. However, when the refresh is determined to be successful, the device reset is initiated. At step 720, the device may be reset. Upon reset, the requested profile is enabled at step 722. Thereafter, a notification is sent to SM-DP+ to notify about the enabled profile, at step 724. After sending notification to the SM-DP+ server, response from the SM-DP+ server is monitored. In case of delay in response from SM-DP+ at step 726, the step 712 is performed again e.g., ongoing communication of the MNO profiles is monitored by the monitor and subsequently, a new port is selected.

However, when the response from the SM-DP+ is received timely without delay, the process moves to close the communication channel at step 728. In case the communication channel is not closed, an error is generated and the step 712 is performed again e.g., ongoing communication of the MNO profiles is monitored by the monitor and subsequently, a new port is selected. However, when the communication channel is closed, the enabling of the profile is completed at step 730.

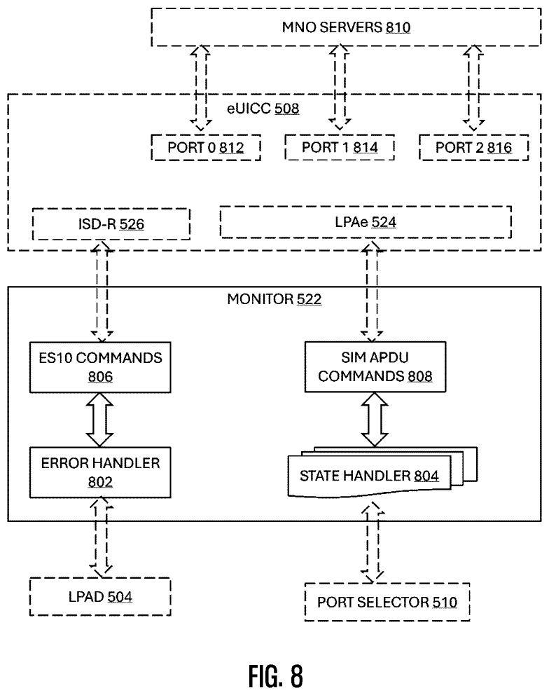

FIG. 8 is a diagram illustrating an example configuration of the monitor 522 along with interconnection of the monitor 522 with the other elements of the device according to various embodiments. As shown in FIG. 8, the monitor 522 comprises error handler 802 and state handler 804, but not limited thereto. The monitor 522 also stores Es10 commands 806 and SIM APDU commands 808, but is not limited thereto. In FIG. 8, eUICC 508 comprises PORT 0 812, PORT 1 814, PORT 2 816, an ISD-R 526 and an LPAe 524, but not limited thereto.

When any error occurs during the enable/disable profile process, then ISD-R 526 sends the Es10 error command to the monitor 522. The error handler 802, which is communicatively linked to the device LPA 504, is responsible for managing error notifications. Whenever an error is generated, the error handler 802 communicates the same to device LPA 504. In an embodiment, the error may be generated due to non-closure of the previous channel (as shown at step 6.7 of FIG. 6). In an embodiment, the error may be generated due to failure in refresh (as shown at step 6.12 of FIG. 6). In an embodiment, the error may be due to delay in response from the SM-DP+server (see step 6.19 of FIG. 6). Further, the error handler 802 may inform the state handler 804 in an event of the error. The state handler 804 stores state of ongoing communication of all profiles and send all ongoing communication data with ICCID to port selector 510 via proactive command if requested by the error handler 802. The LPAe 524 sends the ongoing communication of MNO and profiles to the monitor 522 via the SIM APDU command. The ongoing communication is between the MNO servers 810 and profiles which is based on services provided by the MNO servers 810, such as Non-Terrestrial Networks (NTN), health, etc.

In this manner, by integrating these components, the monitor 522 effectively manages error detection and state tracking.

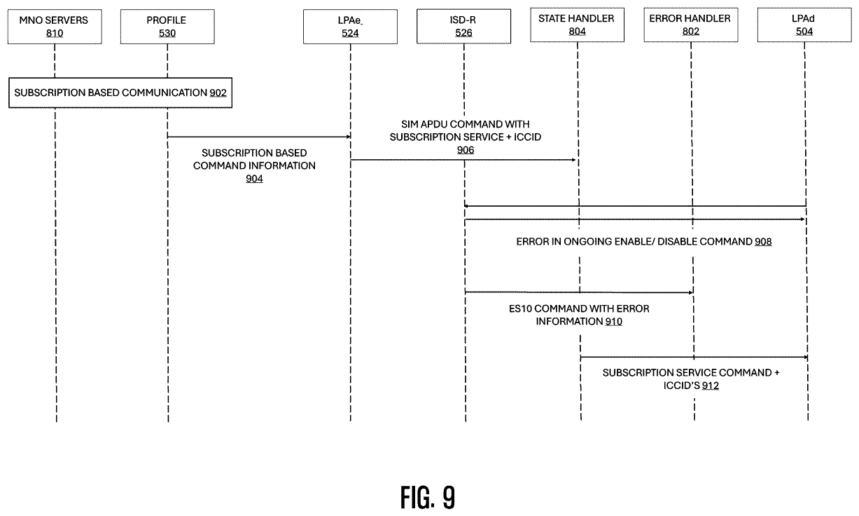

FIG. 9 is a signal flow diagram illustrating example operations for the monitor 522 according to various embodiments. The subscription-based interaction may be ongoing between e-SIM profile 530 and MNO servers 810, as shown at step 902. At step 904, subscription based command information may be sent from the profile 530 to the LPAe 524. The LPAe 524 may send SIM APDU command with subscription service and ICCID to the state handler 804. The state handler 804 may store this information and if any error occurred in the ongoing enable/disable request then ISD-R 526 may inform the error handler 802 of the monitor 522. The LPAd 504 may send “error in Ongoing Enable/Disable” command to the ISD-R 526, at step 908. This command notifies the ISD-R 526 of issues encountered during the profile management process. Subsequently, the ISD-R 526 may send Es10 command with detailed error information to the error handler 802, at step 910. Lastly, the state handler 804 may transfer the subscription communication data to port selector 510 of the LPAd 504 to facilitate selection of new port.

In this manner, the monitor 522 effectively detects and communicates errors, and facilitates the selection of alternative ports when necessary to maintain seamless profile management operations.

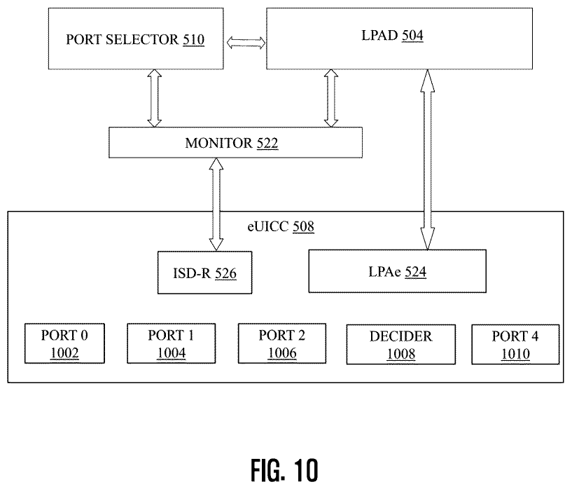

FIG. 10 is a diagram illustrating example interconnection of the port selector 510 with other elements of the device according to various embodiments. In FIG. 10, eUICC 508 comprises PORT 0 1002, PORT 1 1004, PORT 2 1006, PORT 4 1010, a decider 1008, an ISD-R 526, and an LPAe 524, but not limited thereto. The monitor 522 sends all ongoing communication data with ICCID to the port selector 510, if any failure is reported in/able/disable command. The port selector 510 then utilizes this data to determine the most appropriate port for ES10 communication. The port selector 510 evaluates the monitored communication activity associated with each available port and selects a port based on the ongoing communication. This ensures that the communication remains efficient and uninterrupted, even in the event of errors or failures in profile management commands.

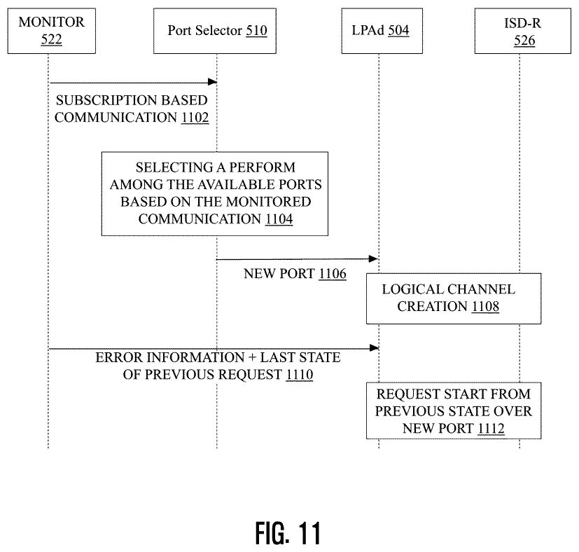

FIG. 11 is a signal flow diagram illustrating example operations for the port selector 510 according to various embodiments. At step 1102, if any error has occurred between ongoing transactions, the state handler 804 transfers the subscription communication data to the port selector 510. This data includes details about the ongoing subscription communication and relevant ICCID information. At 1104, the port selector 510 may select a new port on the basis of ongoing subscription communication and current user context. The port selector 510 may inform the LPAd 504 about the new port, as shown at 1106. At 1108, the LPAd 504 may send the request to the ISD-R 526 to close the previous channel and create a new channel over the new port. If the new port selection is a result of an error, the monitor 522 provides the error information and the last state of the previous request to the LPAd 504 at 1110. At 1112, the LPAd 504 then requests the ISD-R 526 to resume the process from the same point where it was interrupted, thereby facilitating a seamless transition and recovery.

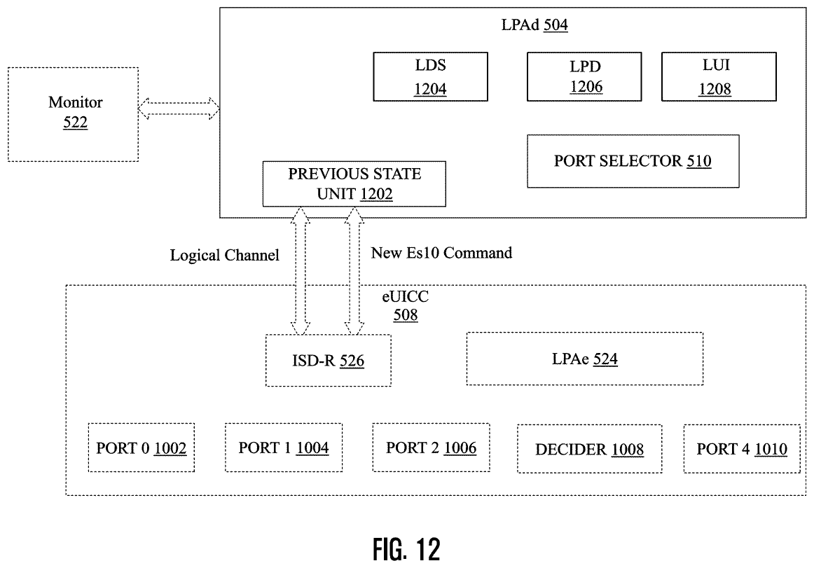

FIG. 12 is a block diagram illustrating an example configuration of the Device LPA (LPAd) 504 along with the interconnection of the LPAd 504 with the other elements of the device according to various embodiments. In FIG. 12, LPAd 504 comprises an LDS (local data store) 1204, an LPD (local profile database) 1206, an LUI (local user interface) 1208, a port selector 510, and a previous state unit 1202, and eUICC 508 comprises PORT 0 1002, PORT 1 1004, PORT 2 1006, PORT 4 1010, a decider 1008, an ISD-R 526, and an LPAe 524, but not limited thereto. The port selector 510 is responsible for selecting a new port. When the port selector 510 selects the new port, the LPAd 504 may send the request to the ISD-R 526 to close the previous communication channel and create a new open channel. For example, if previously the ISD-R 526 communicates with LPAd 504 via port 0, when the new channel request is received from the LPAd 504, then the ISD-R 526 closes the channel over PORT 0 and creates the new logical channel over PORT 1. In an embodiment, the monitor 522 may inform the LPAd 504 about error in ongoing request. The LPAd 504 may store the current state of the request, in the previous state unit 1202. A Es10 command may be sent by the LPAd 504 to the monitor 522 to start the request from previous state over the new channel. In an embodiment, the monitor 522 provides the error information and the last state of the previous request to the LPAd 504. The LPAd 504 then requests the ISD-R 526 to resume the process from the same point where it was interrupted. The ISD-R 526 or the LPAe 524 may decide if request should start from the previous state.

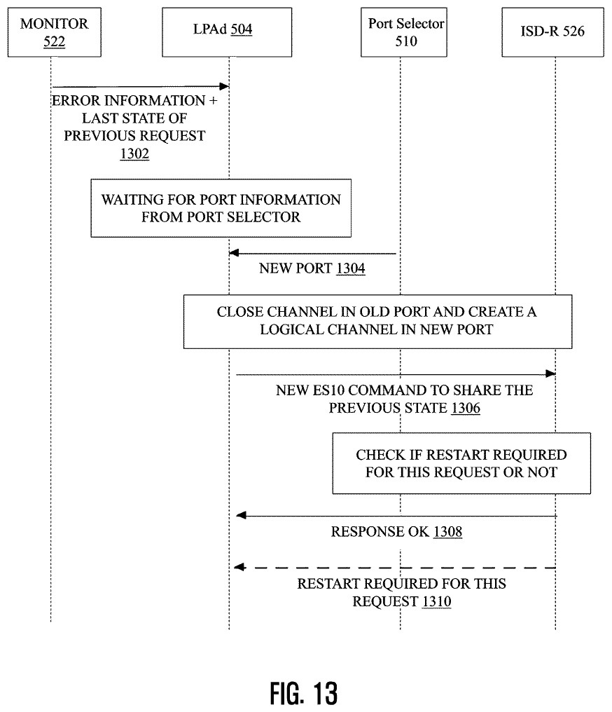

FIG. 13 is a signal flow diagram illustrating example operations for the LPAd 504 according to various embodiments. The error handler 802 of the monitor 522 may transfer error information to the LPAd 504 in ongoing profile transactions, as shown at step 1302. Subsequently, the port selector 510 may select a new port, at step 1304, based on ongoing subscription communication and inform the LPAd 504 about the new port. The LPAd 504 waits for port information of the new port from the port selector 510. Upon receiving the new port, the channel on the old port may be closed and a new logical channel is created on the new port. In an embodiment, the LPAd 504 may send a request to the ISD-R 526 to close the previous channel and create the new channel over the new port. At step 1306, the LPAd 504 may request the ISD-R 526 to start the process from the same point. For this, the LPAd 504 may send a new Es10 command to share the previous state to the ISD-R 526. The ISD-R 526 may check if process needs to restart or can be started from previous state and share the response to the LPAd 504. Accordingly, the LPAd 504 may either receive a ‘ok’ response from the ISD-R 526 at 1308, or may receive a notification that restart is required for the request, at step 1310.

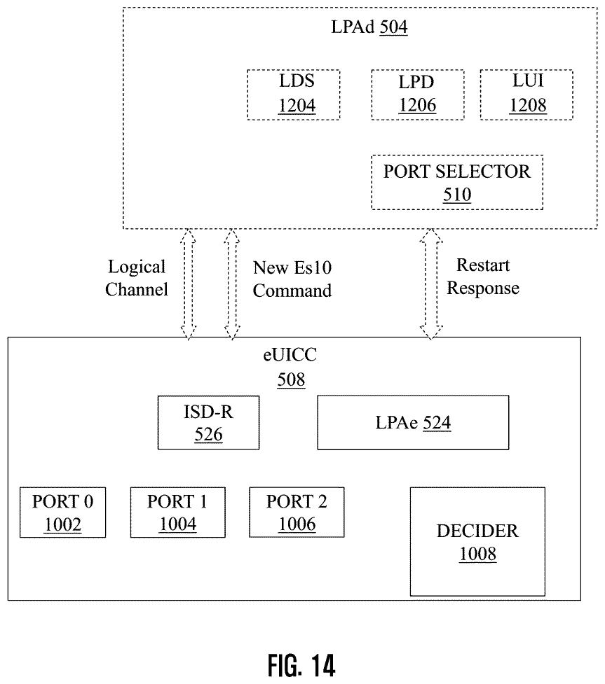

FIG. 14 is a block diagram illustrating an example configuration of the ISD-R 526 along with interconnection of the ISD-R 526 with the other elements of the device according to various embodiments. In FIG. 14, LPAd 504 comprises an LDS (local data store) 1204, an LPD (local profile database) 1206, an LUI (local user interface) 1208, and a port selector 510, and eUICC 508 comprises PORT 0 1002, PORT 1 1004, PORT 2 1006, a decider 1008, an ISD-R 526, and an LPAe 524, but not limited thereto. When the port selector 510 shares a new port, the LPAd 504 may send a request to the ISD-R 526 to close the previous communication channel and create a new channel. Along with this, a new Es10 command may also be sent by the LPAd 504 to the ISD-R 526 to start the request from a previous state over the new channel. The decider 1008 determines if the ISD-R 526 or the LPAe 524 is able to start the previous request. If failure requires a restart, then the process is started again over the new port. After getting response from the ISD-R 526, the LPAd 504 may send the request to the ISD-R 526 to start the transaction again.

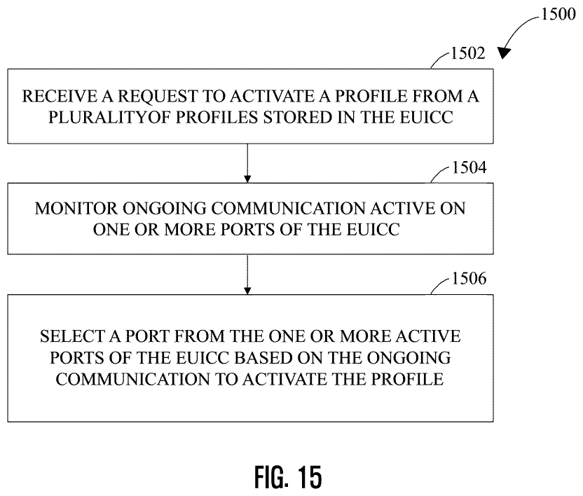

FIG. 15 is a flowchart illustrating an example method for dynamically selecting a port of an Embedded Universal Integrated Circuit Card (eUICC) supporting Multiple Enabled Profiles (MEP) mode in a device, according to various embodiments. The blocks of the flow diagram shown in FIG. 15 have been arranged in a generally sequential manner for ease of explanation; however, it is to be understood that this arrangement is merely an example, and it should be recognized that the functionality/processing associated with method 1500 (and the blocks shown in FIG. 15) can occur in a different order (for example, where at least some of the functionality/processing associated with the blocks is performed in parallel and/or in an event-driven manner).

In block 1502, the method 1500 receives a request to activate a profile from a plurality of profiles stored in the eUICC. At block 1504, the method 1500 monitors ongoing communication on one or more active ports of the eUICC. The ongoing communication relates to mobile network operator (MNO) services supported by one or more currently active profiles corresponding to the one or more active ports. At block 1506, the method 1500 selects a port from the one or more active ports of the eUICC based on the ongoing communication to activate the profile. In enable selection of the port from the one or more active ports of the eUICC based on the ongoing communication, information of the ongoing communication may be stored using a monitor module. The information on the ongoing communication may be transferred from the monitor 522 to the port selector 510. The port may be selected from the one or more active ports by the port selector module 510.

The method 1500 further creates a communication channel between a Local Profile Assistant (LPA) of the device (LAPd) 504 and an Issuer Security Domain-Root (ISD-R) 526 on the selected port. The method comprises sending a command, from the LPAd 504 to the ISD-R 526, to deactivate a currently active profile on the selected port by closing a previous logical communication channel associated with the selected port and to activate the profile indicated in the received request. After receiving the command to deactivate the currently active profile and to activate the profile, it may be determined, by the ISD-R 526, whether the previous logical communication channel is closed or open. Based on the determining, one of following may be performed: i) when the previous logical communication channel is closed, the a refresh request may be initiated for updating the plurality of profiles on the eUICC 508 to deactivate the currently active profile and activate the profile, and ii) when the previous logical communication channel is open, a new port with least priority may be selected based on the ongoing communication and re-initiating creation of the communication channel between the LPA and ISD-R on the new port.

The method further determine whether the refresh request is successful or failed, and based on the determining, one of following may be performed: i) when the refresh request is successful, a reset process may be initialized for the device to activate the profile; and ii) when the refresh request is failed, a new port with least priority may be selected based on the ongoing communication and the communication channel may be created between the LPA and ISD-R on the new port. After initializing the reset process for the device to activate the profile, the method may send a notification to a Subscription Manager Data Preparation (SM-DP+) server 538 related to enabling of the profile. The response from the SM-DP+ server 538 in reply to the notification may be monitored. It may be determined whether the reply is received from the SM-DP+ server within a predefined time period. Upon a non-receipt of the reply from the SM-DP+ server 538 within the predefined time period, a new port with least priority may be selected based on the ongoing communication and the communication channel between the LPA and ISD-R may be created on the new port.

In an embodiment, upon receiving the new port, the channel on the old port may be closed and a new logical channel is created on the new port. In an embodiment, the method may comprise sending a request from the LPAd 504 to the ISD-R 526 to close the previous channel and create the new channel over the new port. The LPAd 504 may request the ISD-R 526 to start the process from same point. For this, a new Es10 command may be sent from LPAd 504 to the ISD-R 526 to share the previous state. The ISD-R 526 may check if process needs to restart or can be started from previous state and share the response to the LPAd 504. Accordingly, the LPAd 504 may either receive an ‘ok’ response from the ISD-R 526, or may receive a notification that restart is required for the request.

Upon a receipt of the reply from the SM-DP+ server 538 within the predefined time period, closing of the communication channel between the LPA and the ISD-R may be initialized. It may be determined whether the communication channel is closed. Based on the determining, one of the following may be performed: i) activating the profile when the communication channel is closed and ii) selecting a new port with least priority based on the ongoing communication and re-initiating creation of the communication channel between the LPA and ISD-R on the new port when the communication channel is failed to close.

In this manner, the method provides effective and efficient profiles management within the eUICCs by introducing dynamic port selection and robust error handling mechanisms. This ensures greater flexibility and reliability in profile activation and deactivation processes, even in the event of malfunctions or communication failures. The method enables adaptive selection of alternative ports and manage errors effectively to enhance overall operational efficiency and ensures that profile updates are applied promptly and accurately.

The various example embodiments of the present disclosure may be illustrated by way of the following examples.

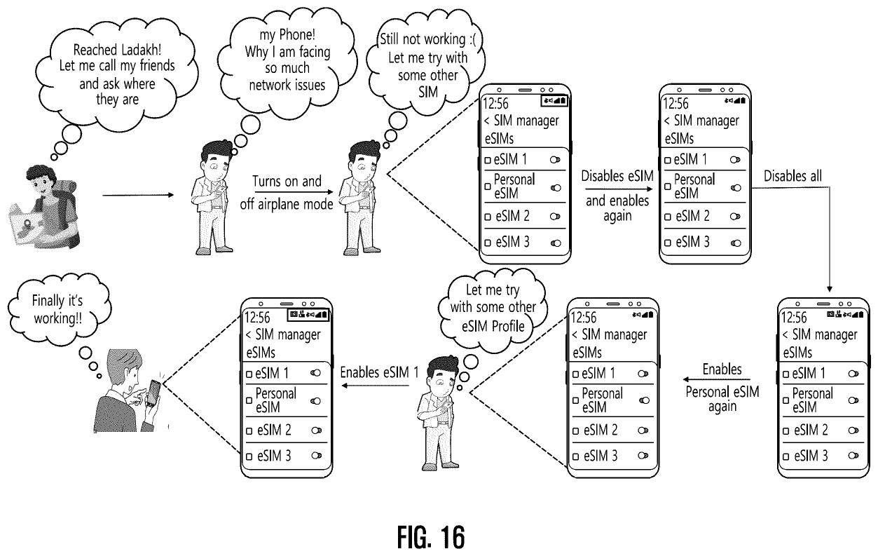

Imagine a tourist who arrives in “Ladakh” and wants to call his friends to find out their location. Upon attempting to make the call, he notices that his mobile device has no network signal, as illustrated in FIG. 16. The tourist might first try toggling airplane mode on and off in the hope to restore the network, but may not resolve the issue. In response, the tourist may decide to disable and then re-enable the eSIM on his device, but this also fails to restore the network. He then attempts to disable all SIMs and re-enable. However, the network issue still remains unresolved and then he may try activating other eSIM profiles. Finally, when he enables eSIM 1, which had previously been disabled, he may be able to regain network connectivity on his mobile device.

In another example, imagine a user traveling in a rural area for a client meeting. His phone may have several network profiles preloaded, and each of them may be associated with different service providers. The user may want to initiate a video call for the meeting to connect with his team. While trying to join the video call, the user may notice that his current network is too slow for a stable connection. The user may use his phone's feature to switch to a different network profile. Within moments, the phone may switch to the new network profile that provides a stronger and more stable connection. As a result, the user may be able to have the video call without any interruptions. The seamless switch between network profiles helps provide him with better connectivity.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the detailed description.

The order in which the various operations of the methods are described is not intended to be construed as a limitation, and any number of the described method blocks can be combined in any order to implement the method. Additionally, individual blocks may be deleted from the methods without departing from the spirit and scope of the subject matter described herein. Furthermore, the methods can be implemented in any suitable hardware, software, firmware, or combination thereof.

It may be noted here that the subject matter of some or all embodiments described with reference to the drawings may be relevant for the methods and the same is not repeated for the sake of brevity.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in Figures, those operations may be performed by any suitable corresponding counterpart means-plus-function components.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the various embodiments described herein. The term “computer-readable medium” should be understood to include tangible items and exclude carrier waves and transient signals, e.g., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Certain aspects may comprise a computer program product for performing the operations presented herein. For example, such a computer program product may comprise a computer readable media having instructions stored (and/or encoded) thereon, the instructions being executable by one or more processors to perform the operations described herein. For certain aspects, the computer program product may include packaging material.

Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

As used herein, a phrase referring to “at least one” or “one or more” of a list of items refers to any combination of those items, including single members. As an example, “at least one of: a, b, or c” is intended to cover: a, b, c, a-b, a-c, b-c, and a-b-c. The terms “a”, “an” and “the” may refer to “one or more”, unless expressly specified otherwise. The terms “including”, “comprising”, “having” and variations thereof, when used in a claim, is used in a non-exclusive sense that is not intended to exclude the presence of other elements or steps in a claimed structure or method, unless expressly specified otherwise.

Finally, the language used in the disclosure has been selected for readability and instructional purposes, and it may not have been selected to delineate or circumscribe the subject matter. It is therefore intended that the scope of the disclosure be limited not by this detailed description. Accordingly, the various example embodiments of the present disclosure are intended to be illustrative, but not limiting, of the scope of the disclosure, including the appended claims and their equivalents. It will also be understood that any of the embodiment(s) described herein may be used in conjunction with any other embodiment(s) described herein.

What is claimed is:

1. A method for dynamically selecting a port of an Embedded Universal Integrated Circuit Card (eUICC) supporting Multiple Enabled Profiles (MEP) mode in a device, the method comprising:
receiving a request to activate a profile from a plurality of profiles stored in the eUICC;
monitoring ongoing communication on one or more active ports of the eUICC; and
selecting a port from the one or more active ports of the eUICC based on the ongoing communication to activate the profile.

2. The method of claim 1, wherein the ongoing communication relates to mobile network operator (MNO) services supported by one or more currently active profiles corresponding to the one or more active ports.

3. The method of claim 1, wherein for selecting the port from the one or more active ports of the eUICC based on the ongoing communication, the method further comprises:
storing information of the ongoing communication using a monitor module;
transferring the information of the ongoing communication from the monitor module to a port selector module; and
selecting the port from the one or more active ports by the port selector module.

4. The method of claim 1, further comprising:
creating a communication channel between a Local Profile Assistant (LPA) and an Issuer Security Domain-Root (ISD-R) on the selected port; and
sending a command, from the LPA to the ISD-R, to deactivate a currently active profile on the selected port by closing a previous logical communication channel associated with the selected port and to activate the profile indicated in the received request.

5. The method of claim 4, based on receiving the command to deactivate the currently active profile and to activate the profile, the method further comprises:
determining, by the ISD-R, whether the previous logical communication channel is closed; and
performing, based on the determining, one of:
based on the previous logical communication channel being closed, initiating a refresh request for updating the plurality of profiles on the eUICC to deactivate the currently active profile and activate the profile; and
based on the previous logical communication channel being open, selecting a new port with least priority based on the ongoing communication and re-initiating creation of the communication channel between the LPA and ISD-R on the new port.

6. The method of claim 5, further comprising:
determining whether the refresh request is successful; and
performing, based on the determining, one of:
based on the refresh request being successful, initializing a reset process for the device to activate the profile; and
base on the refresh request not being successful, selecting a new port with least priority based on the ongoing communication and re-initiating creation of the communication channel between the LPA and ISD-R on the new port.

7. The method of claim 6, based on initializing the reset process for the device to activate the profile, the method further comprises:
sending a notification to a Subscription Manager Data Preparation (SM-DP+) server related to enabling of the profile;
monitoring a response from the SM-DP+ server in response to the notification;
determining whether the reply is received from the SM-DP+ server within a specified time period; and
based on a non-receipt of the reply from the SM-DP+ server within the specified time period, selecting a new port with least priority based on the ongoing communication and re-initiating creation of the communication channel between the LPA and ISD-R on the new port.

8. The method of claim 7, based on a receipt of the reply from the SM-DP+ server within the specified time period, the method further comprises:
initializing closing of the communication channel between the LPA and the ISD-R;
determining whether the communication channel is closed; and
performing, based on the determining, one of:
activating the profile based on the communication channel being closed; and
selecting a new port with least priority based on the ongoing communication and re-initiating creation of the communication channel between the LPA and ISD-R on the new port based on the communication channel not being closed.

9. An apparatus configured to dynamically select a port of an Embedded Universal Integrated Circuit Card (eUICC) supporting Multiple Enabled Profiles (MEP) mode in a device, the apparatus comprises:
at least one processor, comprising processing circuitry, individually and/or collectively, configured to:
receive a request to activate a profile from a plurality of profiles stored in the eUICC;
monitor ongoing communication on one or more active ports of the eUICC; and
select a port from the one or more active ports of the eUICC based on the ongoing communication.

10. The apparatus of claim 9, wherein the ongoing communication relates to mobile network operator (MNO) services supported by one or more currently active profiles corresponding to the one or more active ports

11. The apparatus of claim 9, wherein to select the port from the one or more active ports of the eUICC based on the ongoing communication, at least one processor, individually and/or collectively, is configured to:
store information of the ongoing communication using a monitor module;
transfer the information of the ongoing communication from the monitor module to a port selector module; and
select the port from the one or more active ports by the port selector module.

12. The apparatus of claim 9, at least one processor, individually and/or collectively, is configured to:
create a communication channel between a Local Profile Assistant (LPA) and an Issuer Security Domain-Root (ISD-R) on the selected port; and
send a command, from the LPA to the ISD-R, to deactivate a currently active profile on the selected port by closing a previous logical communication channel associated with the selected port and to activate the profile indicated in the received request.

13. The apparatus of claim 12, based on receiving the command to deactivate the currently active profile and to activate the profile, at least one processor, individually and/or collectively, is configured to:
determine, using the ISD-R, whether the previous logical communication channel is closed; and
perform, based on the determination, one of:
based on the previous logical communication channel being closed, initiate a refresh request for updating the plurality of profiles on the eUICC to deactivate the currently active profile and activate the profile; and
based on the previous logical communication channel being open, select a new port with least priority based on the ongoing communication and re-initiating creation of the communication channel between the LPA and ISD-R on the new port.

14. The apparatus of claim 13, at least one processor, individually and/or collectively, is configured to:
determine whether the refresh request is successful; and
perform, based on the determination, one of:
based on the refresh request being successful, initialize a reset process for the device to activate the profile; and
based on the refresh request not being successful, select a new port with least priority based on the ongoing communication and re-initiating creation of the communication channel between the LPA and ISD-R on the new port.

15. The apparatus of claim 14, based on initializing the reset process for the device to activate the profile, at least one processor, individually and/or collectively, is configured to:
send a notification to a Subscription Manager Data Preparation (SM-DP+) server related to enabling of the profile;
monitor a response from the SM-DP+ server in reply to the notification;
determine whether the reply is received from the SM-DP+ server within a specified time period; and
based on a non-receipt of the reply from the SM-DP+ server within the specified time period, select a new port with least priority based on the ongoing communication and re-initiating creation of the communication channel between the LPA and ISD-R on the new port.

16. The apparatus of claim 15, based on a receipt of the reply from the SM-DP+ server within the specified time period, at least one processor, individually and/or collectively, is configured to:
initialize closing of the communication channel between the LPA and the ISD-R;
determine whether the communication channel is closed; and
perform, based on the determination, one of:
activate the profile based on the communication channel being closed; and
select a new port with least priority based on the ongoing communication and re-initiating creation of the communication channel between the LPA and ISD-R on the new port based on the communication channel not being closed.
